(19) United States
(12) Patent Application Publication
(10) Pub. No.: US 2026/0180337 A1
(43) Pub. Date: Jun. 25, 2026

(54) DYNAMIC STABILITY ASSESSMENT AND OPTIMIZATION FOR MIXED ENERGY POWER GRID OPERATIONS

(71) Applicant: Siemens Aktiengesellschaft, Munich (DE)

(72) Inventors: Ulrich Muenz, Princeton, NJ (US); Chris Oliver Heyde, Erlangen (DE); Rainer Krebs, Erlangen (DE); Ashmin Mansingh, Maple Grove, MN (US)

(73) Assignee: Siemens Aktiengesellschaft, Munich (DE)

(21) Appl. No.: 19/129,840

(22) PCT Filed: Aug. 29, 2023
(86) PCT No.: PCT/US2023/031381

§ 371 Date: May 14, 2025

Related U.S. Application Data
(60) Provisional application No. 63/383,935, filed on Nov. 16, 2022.

(51) Int. Cl. H02J 3/38; G06Q 10/04; G06Q 50/06; H02J 3/00

(52) U.S. Cl. CPC H02J 3/381; G06Q 10/04; G06Q 50/06; H02J 3/00

(57) ABSTRACT

System and method ensure stability of power transmission system or power grid with mixed generation sources of renewable and non-renewable types while providing a best combination of stability services that minimizes both cost of generation and guaranteed reliability. An energy market management (EMM) module derives an energy market dispatch for a mix of generation sources including renewable and conventional types based on a steady state optimization of supplier cost and a power demand forecast. Dynamic Security Assessment (DSA) module performs a dynamic contingency assessment of stability for the power transmission system based on the energy market dispatch and sends feedback to the EMM module with results of the dynamic assessment of stability. EMM module clears the energy market dispatch on a condition that feedback indicates a stable dynamic assessment. For unstable assessment, data driven, model-based and/or rule-based algorithms provide recommendations on how EMM module can find stable market solutions.

### TECHNICAL FIELD

This application relates to power grid operations. More particularly, this application relates dynamic assessment and optimization of system stability for a power grid with mixed generation sources of renewable energy and non-renewable energy (fossil fuels).

### BACKGROUND

Power systems are experiencing a tremendous growth in renewable energy generation, especially wind and solar, but also batteries and electric vehicle (EV) chargers, to meet carbon-reduction targets. This leads to a transition in power system dynamics from synchronous-generator-dominated to power-electronics-dominated power system dynamics. Conventional power plants supply electrical currents to the power grid using synchronous generators whereas renewable energy power plants (e.g., wind, solar, batteries and EV chargers) supply currents using power electronic inverters. Beyond the change in power system dynamics, the dynamics are also becoming more volatile depending on the mix of generation sources. For instance, the power system dynamics may depend on whether there is high or low wind and solar generation and how it is geographically distributed.

Potential problems faced by grids that operate with renewable energy generation sources include oscillations between the multiple inverters connected to the grid, which causes instability of the power delivery to the system loads. A solution is for a renewable energy supplier and other grid asset owners to provide “stability services”, which include software based controllers on one or more generators, such as a wind turbine, to adjust output power as necessary for keeping the inverter oscillations in check. Examples for stability services include grid-forming, fast frequency response, or virtual inertia. The downside is that the generator selected for such a stability service controller must be capped to a lower maximum delivery capacity than the available maximum power so that a range of adjustable output power between the delivery and the available maximum is always available to the stability service controller (i.e., avoiding the adjustable range from reaching the maximum level). Consequently, a nominal reduction range (e.g., 5-10%) is set for output delivery of the stability service controlled generator. The supplier charges a service fee to the buyer (power system operator) for this stability service as compensation for the reduction in actual power delivery for these controlled generators.

When operating the power grid with an open power market, an independent system operator may switch power suppliers to meet power demand while minimizing the cost of generation suppliers. This requires planning of resources by the operator to dispatch a request in advance to generation suppliers of the energy market. For example, the operator forecasts the hourly power demand for the power transmission system and the dispatch defines the amount of power to be delivered by each of x coal power plants, y wind turbines, and z solar farms. The power system dynamics are expected to change following the energy market dispatch within hours and days. This leads to a new problem for energy markets. As the energy market is cleared by filling all dispatch orders, the clearing process should include accounting for possible dynamic stability risks and risks of blackouts. This means that certain generation mixes (especially those with high wind and solar generation) that would be financially attractive will either not be feasible without high risk of blackouts or will require additional stability services to ensure power system stability and to avoid blackouts.

In today's energy market however, the above-mentioned problem does not yet exist because the integration of wind and solar generation is still relatively low. With little need for dynamic concerns, the power system stability is analyzed by planning teams offline, i.e., not during operation or for each market dispatch. This is feasible because most fossil fueled power plants run 24/7, which leads to almost constant power system dynamics from day to day, week to week, and year to year. Today's energy market tools like Siemens' Energy Market Management (EMM) provide a steady state analysis, but not a dynamic one.

There exist online tools like Siemens' Siguard Dynamic Security Assessment (DSA) that offer online simulation to analyze the dynamic stability of the power system. These tools are used, for example, by grid operators or transmission system operators (TSOs) with high level of wind and solar generation. These tools can take the energy market dispatch as an input to analyze whether this assigned lineup of power generators creates an unstable power system for various contingencies (e.g., can the power transmission system supply the load demand in the event of a power line loss, or a generator loss). However, currently there is no mechanism to change the energy market clearing in case there is an assessment that the market clearance may produce unstable power system behavior, i.e., there lacks any feedback from DSA into the energy market clearance process.

### SUMMARY

System and method are provided for dynamic assessment and optimization of stability for a power grid with mixed generation sources of renewable energy and non-renewable energy (fossil fuels).

In an aspect, a computer implemented method includes an EMM module deriving an energy market dispatch for a mix of generation sources including renewable and non-renewable types based on an optimization of supplier cost and power demand by an energy market. A DSA module receives the dispatch, performs a dynamic assessment of stability for the power transmission system based on the mixed generation sources defined by the energy market dispatch, and sends feedback to the EMM module with results of the dynamic assessment of stability. The EMM module clears the energy market dispatch on a condition that feedback indicates a stable dynamic assessment.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows a block diagram for an example of a computer-based system for performing energy market planning based on feedback from a dynamic security assessment module in accordance with embodiments of this disclosure.

FIG. 2 shows a block diagram for an example of a computer-based system for performing energy market planning based on feedback from a dynamic security assessment module using a rule-based stability service agent in accordance with embodiments of this disclosure.

FIG. 3 shows a block diagram for an example of a computer-based system for performing energy market planning based on feedback from a dynamic security assessment module using dynamic security optimization in accordance with embodiments of this disclosure.

FIG. 4 shows a block diagram for an example of a computer-based system for performing energy market planning based on feedback from a dynamic security assessment module using a reinforcement learning (RL)-based stability service agent in accordance with embodiments of this disclosure.

FIG. 5 shows a block diagram for an example of a training scheme used to train the (RL)-based stability service agent of FIG. 4 in accordance with embodiments of this disclosure.

FIG. 6 illustrates an example of a computing environment in which embodiments of the present disclosure may be implemented.

### DETAILED DESCRIPTION

Systems and methods are disclosed for ensuring stability of a power transmission system or power grid with mixed generation sources of renewable and non-renewable types while providing a best combination of stability services that minimizes both cost of generation and guaranteed reliability. A local energy market of a power grid is formed of power supply units (non-renewable and renewable energy generators) and power consumption units (consumer loads on the power grid). Electrical energy is provided by means of power generation and/or by means of stored electrical energy and/or by means of stored energy that is converted into electrical energy. Power supply units are in particular combined heat and power plants (abbreviated: CHP), photovoltaic systems, wind turbines, biogas power plants, hydropower plants, pumped storage power plants, tidal power plants, geothermal plants and/or energy storage. The power grid system operator is responsible for selecting a set of suppliers from multiple conventional suppliers and renewable energy supplier entities that offer stability services with varying service cost rates. The disclosed system provides a mechanism for optimizing the selection of power suppliers for both system reliability and cost. One additional objective may include minimizing the carbon dioxide emissions per energy unit by minimizing non-renewable energy supplier units in the mix. As a measure for operators to ensure reliability of the power grid, stability services may be offered which can include any one or more of the following: power grid assets such as Flexible AC Transmission Systems (FACTS), High-Voltage Direct Current (HVDC) terminals, synchronous condensers, controllable non-renewable generators, battery storage systems, and controllable loads.

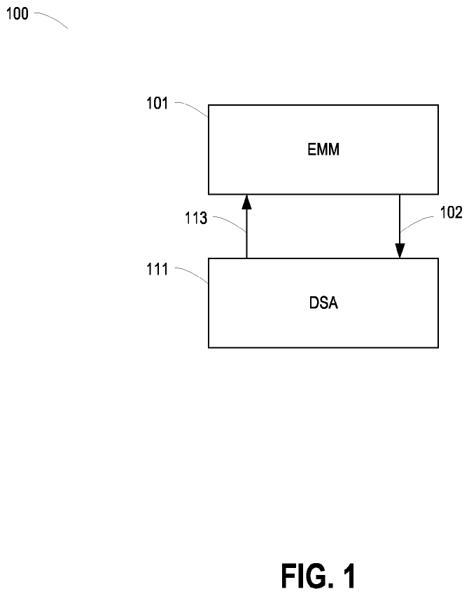

FIG. 1 shows a block diagram for an example of a computer-based system for performing energy market planning based on feedback from a dynamic security assessment module in accordance with embodiments of this disclosure. According to computer-based system 100, energy market management (EMM) module 101 is configured to perform energy market planning based on forecasted consumer demand and optimizing to a target function (e.g., minimizing cost) using a steady state power flow analysis. EMM module 101 generates a dispatch 102 that includes information on assets that satisfy the target function. DSA module 111 receives the dispatch information 102 and performs a dynamic stability assessment that determines whether the dispatched lineup of assets can withstand a dynamic contingency analysis (e.g., N−1 contingency). The assessment result is sent as feedback 113 to EMM module 101. On a condition that the feedback 113 indicates a stable assessment, EMM module 101 provides clearance for the energy market according to the dispatch. Using this communication exchange between EMM module 101 and DSA module 111, stability services can be controlled as a platform in which asset owners can offer these services and then the various offers are analyzed by both EMM module 101 and DSA module 111 to find the best combination of stability services that minimizes both cost of generation and guaranteed reliability that supports the final clearance. The feedback from DSA module 111 is a significant technical solution to the state of the art approach where assurance of service stability is not provided.

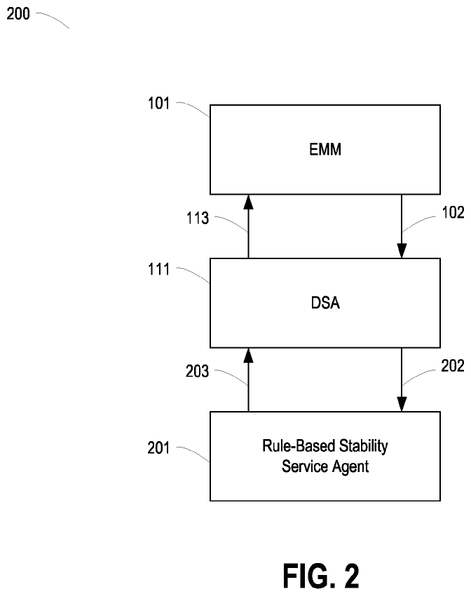

FIG. 2 shows a block diagram for an example of a computer-based system for performing energy market planning based on feedback from a dynamic security assessment module using a rule-based stability service agent in accordance with embodiments of this disclosure. In the event that DSA module 111 determines an unstable assessment, a rule based stability service agent 201 is configured with rule based algorithms to identify stability services and asset locations 203 based on contingency assessment 202. DSA module 111 quantifies an amount of stability services (e.g., (virtual) inertia, short circuit power, reserve, etc.) and provides this information 113 to EMM module 101. The dispatch information is revised by EMM module 101 to include request for stability services and energy market clearance is improved with dynamic stability. In an embodiment, rule based stability service agent 201 is a submodule of DSA module 111.

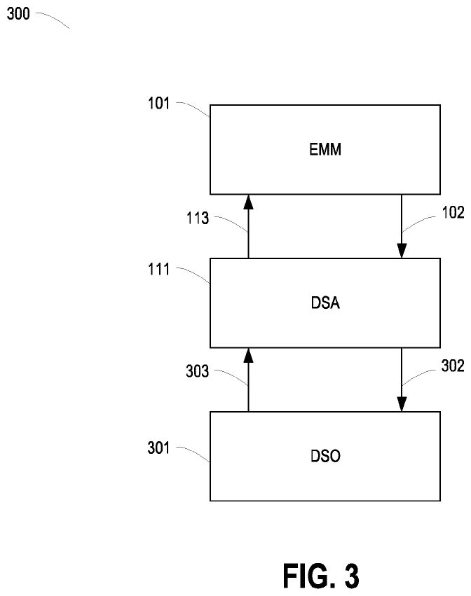

FIG. 3 shows a block diagram for an example of a computer-based system for performing energy market planning based on feedback from a dynamic security assessment module using dynamic security optimization in accordance with embodiments of this disclosure. In an embodiment, a computer based system 300 includes EMM module 101, DSA module 111 and a dynamic security optimization (DSO) module 301 configured to maximize stability and performance of the existing assets from the original dispatch 102 in the event DSA module 111 contingency assessment 302 indicates an unstable condition. The addition of DSO module 301 to the combination of EMM module 101 and DSA 111 provides a capability for adjustment of tunable parameters of the available generation sources (e.g., non-renewable energy sources) as well as the generation sources of the stability services being offered to EMM module 101. In the event that DSA module 111 determines an unstable assessment, DSO module 301 is configured to identify stability services and asset locations based on contingency assessment 302. For each of the different stability service assets, DSO module 301 optimizes the tunable (controller) parameters that improve the resiliency/stability for the identified contingencies and sends those optimized controller parameters 303 to DSA module 111. From optimized parameters 303, DSA module 111 reruns the contingency assessment using higher fidelity than the simplified model used by DSO module 301. quantifies an amount of stability services (e.g., (virtual) inertia, short circuit power, reserve, etc.) and provides this information 113 to EMM module 101. The dispatch information is revised by EMM module 101 to include request for stability services and energy market clearance is improved with dynamic stability. In an embodiment, DSO module 301 is a submodule of DSA module 111.

DSO module 301 operates on the principle of optimizing tunable controller parameters of existing controllers in the power system grid, such as Proportional-Integral-Differential (PID) controllers of PV batteries or non-renewable energy generators. According to an aspect, an optimization problem is solved in a computer-assisted manner upon activation by DSA module 111.

The proposed approach for DSO module 301 is based on H. (i.e., h-infinity) optimization, an optimization method for dynamic systems used widely for optimal control of chemical processes and mechanical systems. To apply parameter tuning optimization, a power system model is needed. Furthermore, contingencies (failures) must be modelled appropriately before the parameter tuning optimization problem can be defined. The model considers an arbitrary number of consumers and producers (prosumers), interconnected by a power grid. The power grid is modelled either with algebraic equations (i.e., standard power flow equations), or as a dynamic system with continuous states, typically called electromagnetic transient (EMT) equations. Herein, power grid equations are represented by algebraic equations for demonstration.

Furthermore the power system model contains prosumer models, which may vary in complexity from constant inputs (e.g., the power demand of residential customer loads), to full-scale dynamic models of conventional power plants consisting of several parts, and grid-forming and grid-following inverter models. Some prosumers have controllers with tunable parameters denoted by vectors Kᵢ.

By combining equations of the power grid with prosumer models, a nonlinear state-space power system model (PSM) is obtained, which can be expressed as follows:

$$x = f ( x , u , d , K )$$

$$y = h ( x , u , d , K )$$

where x is a vector which comprises all continuous states in the system,
   y as the vector of frequencies of dynamic prosumers,
   u is a vector of external inputs into the system, such as power, voltage, and frequency setpoints,
   d is a vector of contingencies disturbances whose impact on the system output y is reduced by parameter tuning,
   K is a vector of tunable parameters of all prosumers in the system,
   f represents the system model/equations (also including algebraic equations), and
   h defines the system performance output y, used to evaluate the dynamic system performance.

Contingencies (failures) are typically modelled as a structural change in the system. A power line outage branch failure, such as an outage of a power line after a short circuit, is modelled by eliminating the line branch from the power grid equations. Analogously, prosumer failures, such as generator outages, are modelled by disconnecting the prosumer from the grid. Hence, contingencies cannot be trivially modelled as changes in the input u of the power system model. Instead, a separate PSM is typically needed for each contingency model, i.e., we define a number N_{C} of PSMs corresponding to the number of modelled contingencies.

In order to reduce the numerical complexity for the optimization, the nonlinear PSMs are linearized for each contingency around relevant operating points to obtain a set of linear systems.

$${\dot{x}}_{ι} = {A}_{i} ( K ) {x}_{i} + {B}_{u i} ( K ) {u}_{i} + {B}_{di} ( K ) {d}_{i}$$

$${y}_{i} = {C}_{i} ( K ) {x}_{i} + {D}_{u i} ( K ) {u}_{i} + {D}_{di} ( K ) {d}_{i}$$

Note that even though the PSM is linear, the system matrices Aᵢ, Bᵤᵢ, Bₐᵢ, Cᵢ, Dᵤᵢ, Dₐᵢ may still have a nonlinear dependency on the parameter vector K. An objective is to tune vector K to improve the system performance with respect to the disturbance input d and the output y for each contingency.

Finally, the parameter tuning problem can be formulated to minimize the H_{∞} norm of the system. Loosely speaking, the H_{∞} norm describes the damping of oscillations, visible in the output yᵢ, after an excitation from the disturbance input dᵢ. This norm is chosen as it shows good results in practical systems, and it directly improves the robustness of the system. Another suitable norm may be applied as an alternative, such as the H₂ norm, which is a well-known norm defined by the root-mean-square of the impulse response of the system. The solution of the following optimization problem is one controller parameterization K for a set of contingencies N_{C} which improves the system performance for all these contingencies. This can be formulated by the following expressions:

$${min}_{γ , K} γ$$

$$s . t . ( \begin{matrix}γ I & {G}_{i} ( K , j {ω}_{ik} ) \\ {G ( K , j {ω}_{ik} )}^{*} & γ I\end{matrix} ) ≻ 0 , ∀ {ω}_{i k} ∈ {Ω}_{i}$$

$$\underline{K} \leq K \leq \overline{K} ,$$

where Gᵢ is the transfer function from the input dᵢ to the output yᵢ in the linearized PSM above for the i-th contingency,
   Ωᵢ is the set of frequencies where Gᵢ is evaluated, and
   K̅, K are the upper and lower bounds for K, respectively.

By choosing an adequate sampling density for Ωᵢ, it can be shown that the solution of the previous optimization problem will lead to a stabilizing parameterization with an improved H_{∞} performance. The problem can be solved efficiently using a linear matrix inequality solver. The parameter optimization problem requires the system to be initially stable for the controller tuning, which may not be true for some contingencies. In such cases, approaches for stabilization must be used beforehand. With this embodiment relating to DSO module 301, optimized operation of a power grid is easily achieved by means of a simple computer-assisted method which, on the basis of a model of the power grid, calculates suitable values for the tunable controllers of the grid without complicated simulations having to be carried out for this purpose. In this case, the operation of the power grid is optimized to minimize power oscillations and thereby maximize dynamic stability. In an embodiment, other optimization criteria may be targeted in addition to or as an alternative to the above described approach. For example, DSO module 301 may incorporate analysis of stability services such that tunable controllers consider minimizing cost, maximizing resilience, and/or N−1 contingency.

In an embodiment, the computer-based system 200 and 300 may be combined such that DSA module 111 uses both rule based stability service agent 201 and DSO module 301 to provide a set of quantified stability services to EMM module 101 in response to a unstable contingency assessment.

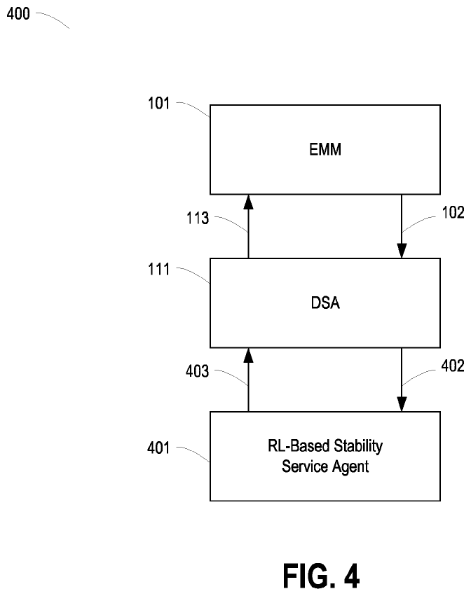

FIG. 4 shows a block diagram for an example of a computer-based system for performing energy market planning based on feedback from a dynamic security assessment module using a reinforcement learning (RL)-based stability service agent in accordance with embodiments of this disclosure. In an embodiment, computer-based system 400 includes EMM module 101, DSA module 111 and a RL-based stability service agent 401 configured to maximize stability and performance of the existing assets from the original dispatch 102 in the event of DSA module 111 contingency assessment 302 indicates an unstable condition. In the event that DSA module 111 determines an unstable assessment 402, RL-based stability service agent 401 is configured to identify stability services and asset locations 403 based on contingency assessment 402. From information 403, DSA module 111 quantifies an amount of stability services (e.g., (virtual) inertia, short circuit power, reserve, etc.) and provides this information 113 to EMM module 101. The dispatch information is revised by EMM module 101 to include request for stability services and energy market clearance is improved with dynamic stability. In an embodiment, RL-based stability service agent 401 is a submodule of DSA module 111.

As an example of continuous optimization parameters, the output delivery for a wind farm may be curtailed by a factor of X % (e.g., 10% of its rated power) in order to create additional headroom of the wind farm to provide fast frequency response or virtual inertia. A discrete optimization parameter, for example, may be an amount of large-scale battery storage (e.g., battery units) to provide grid-forming control behavior instead of grid-following control behavior. This relates to a special control function of the battery which incurs additional cost to the battery supplier, requiring compensation to the battery owner in the energy market. This modification may include a re-dispatch, i.e., the change of the generation mix, as well as a change in the control structures and/or stability services.

In contrast with standard approaches that include mixed-integer (non-) linear programming or genetic algorithms which are typically too slow for online solutions, the system 400 applies RL-based stability service agent 401 that finds a feasible solution to this complex problem within reasonable time, e.g., 5-15 minutes. An RL-based stability service agent 401 is particularly suitable as similar dispatch scenarios require similar stability services.

In general, RL-based stability service agent 401 performs analysis to ensure that the power grid is able to withstand at all times an unexpected failure or outage of a single system component (N−1 contingency) (i.e., has an acceptable reliability level). An N−1 contingency is an event consisting of a loss of a single generator or a transmission component in a grid. An N−1 contingency analysis is performed to assure secure operation of a grid while controlling the active power flow and power dynamics. An objective is to make sure a certain combination of dispatch and stability services ensure that the power grid is still able to remain resilient against N−1 contingencies, therefore minimizing the chances of power outages.

The RL-based stability service agent 401 utilizes RL techniques over graphs and solves the location and sizing of the stability services for one or more of the following challenges:
(a) Possible locations and sizes: The underlying optimization problem have discrete (location) and continuous (size) variables.
(b) Type of stability service and its characteristics: The assets have different characteristics (grid-forming, fast frequency response, virtual inertia, etc.) which makes the optimization problem difficult.
(c) System information (model, topology, etc.): The model has dynamics and certain topology structure. The RL-based stability service agent 401 incorporates this dynamics and topology structure.
(d) Historical operation data (e.g., Phasor Measurement Unit (PMU)/Remote Terminal Unit (RTU) data, event logs, operator notes, etc.): The RL-based stability service agent 401 uses prior knowledge to learn faster and real measurement data to balance the synthetic simulation data.
(e) Financial aspect: The RL-based stability service agent 401 considers the cost of each combination of dispatch and stability services.
(f) Environmental impact: RL-based stability service agent 401 may weigh environmental impact against other aspects, such as financial aspect (e).
(g) N−1 contingencies analysis: Service allocation and sizing by the RL-based stability service agent 401 includes stability analysis so that the power grid can endure a single point failure.

The RL-based stability service agent 401 enables the system 400 to perform financial decision-making for robust stability service allocation and sizing with discrete/continuous choices over internal dynamics model and topological structures utilizing previous knowledge and data. It utilizes reinforcement learning techniques focusing on a mixed-type optimization with graph structure.

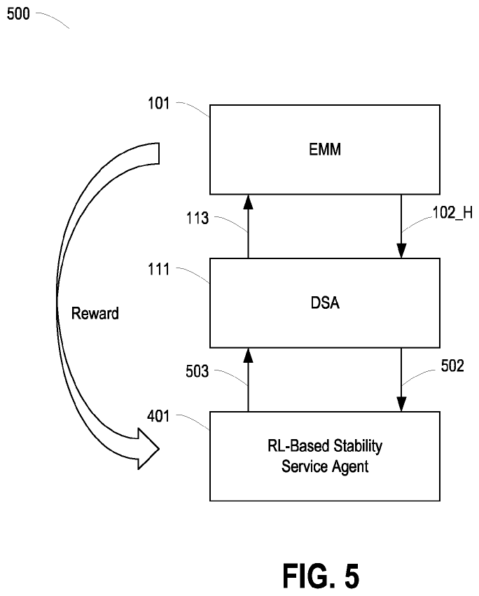

FIG. 5 shows a block diagram for an example of a training scheme used to train the (RL)-based stability service agent of FIG. 4 in accordance with embodiments of this disclosure. The RL-based agent 401 is trained offline using historical dispatch events (especially those that could not be resolved in the past) 102_H for input to DSA module 111, and a contingency assessment 502 from DSA module 111. The RL-based agent 401 is trained offline to find or recruit a good selection of stability services, such as grid-forming, to achieve dynamic stability, reported as output 503. As an example of problem solving, RL-based agent 401 is a good choice for this application as similar problems (e.g., lack of stability because of high wind generation in the north) lead to similar solutions (e.g., increase grid-forming in the north). The RL-based agent 401 can be trained for these typical situations offline and is at the same time very fast for online solution.

In an aspect, the embodiments shown in FIGS. 2, 3, 4 and 5 are combinable. For example, DSA module 111 may comprise one or more of the following modules: rule-based stability service agent 201, DSO 301, and RL-based stability service agent 401. Alternatively, dynamic assessment and optimization of stability for a power grid can be achieved through DSA module 111 in conjunction with modules 201, 301 and 401 implemented as separate modules.

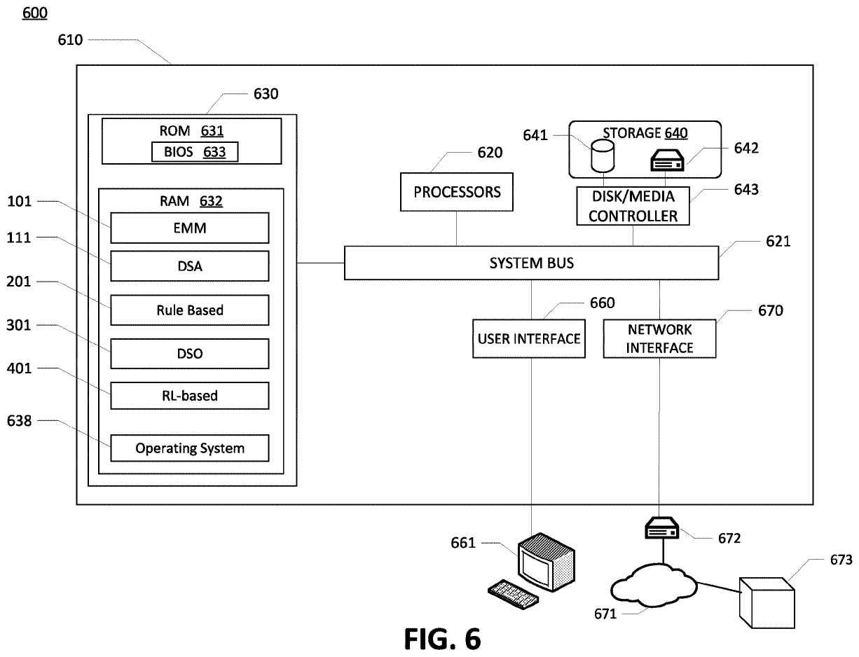

FIG. 6 illustrates an example of a computing environment in which embodiments of the present disclosure may be implemented. A computing environment 600 includes a computer system 610 that may include a communication mechanism such as a system bus 621 or other communication mechanism for communicating information within the computer system 610. The computer system 610 further includes one or more processors 620 coupled with the system bus 621 for processing the information. In an embodiment, computing environment 600 corresponds to a system for modeling reconfigurations of a power transmission system in multiple outage contingencies, in which the computer system 610 relates to a computer described below in greater detail.

The processors 620 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 620 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 621 may include at least one of a system bus, a memory bus, an address bus, or a message bus, and may permit exchange of information (e.g., data (including computer-executable code), signaling, etc.) between various components of the computer system 610. The system bus 621 may include, without limitation, a memory bus or a memory controller, a peripheral bus, an accelerated graphics port, and so forth. The system bus 621 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 6, the computer system 610 may also include a system memory 630 coupled to the system bus 621 for storing information and instructions to be executed by processors 620. The system memory 630 may include computer readable storage media in the form of volatile and/or nonvolatile memory, such as read only memory (ROM) 631 and/or random access memory (RAM) 632. The RAM 632 may include other dynamic storage device(s) (e.g., dynamic RAM, static RAM, and synchronous DRAM). The ROM 631 may include other static storage device(s) (e.g., programmable ROM, erasable PROM, and electrically erasable PROM). In addition, the system memory 630 may be used for storing temporary variables or other intermediate information during the execution of instructions by the processors 620. A basic input/output system 633 (BIOS) containing the basic routines that help to transfer information between elements within computer system 610, such as during start-up, may be stored in the ROM 631. RAM 632 may contain data and/or program modules that are immediately accessible to and/or presently being operated on by the processors 620. System memory 630 additionally includes modules for executing the described embodiments, such as EMM module 101 and DSA module 111, and optionally one or more additional modules, alone or in combination, such as Rule-based stability service agent module 201, DSO module 301, RL-based stability service agent module 401.

The operating system 638 may be loaded into the memory 630 and may provide an interface between other application software executing on the computer system 610 and hardware resources of the computer system 610. More specifically, the operating system 638 may include a set of computer-executable instructions for managing hardware resources of the computer system 610 and for providing common services to other application programs (e.g., managing memory allocation among various application programs). In certain example embodiments, the operating system 638 may control execution of one or more of the program modules depicted as being stored in the data storage 640. The operating system 638 may include any operating system now known or which may be developed in the future including, but not limited to, any server operating system, any mainframe operating system, or any other proprietary or non-proprietary operating system.

The computer system 610 may also include a disk/media controller 643 coupled to the system bus 621 to control one or more storage devices for storing information and instructions, such as a magnetic hard disk 641 and/or a removable media drive 642 (e.g., floppy disk drive, compact disc drive, tape drive, flash drive, and/or solid state drive). Storage devices 640 may be added to the computer system 610 using an appropriate device interface (e.g., a small computer system interface (SCSI), integrated device electronics (IDE), Universal Serial Bus (USB), or FireWire). Storage devices 641, 642 may be external to the computer system 610.

The computer system 610 may include a user interface module 660 for communication with a graphical user interface (GUI) 661, which may comprise one or more input/output devices, such as a keyboard, touchscreen, tablet and/or a pointing device, for interacting with a computer user and providing information to the processors 620, and a display screen or monitor.

The computer system 610 may perform a portion or all of the processing steps of embodiments of the invention in response to the processors 620 executing one or more sequences of one or more instructions contained in a memory, such as the system memory 630. Such instructions may be read into the system memory 630 from another computer readable medium of storage 640, such as the magnetic hard disk 641 or the removable media drive 642. The magnetic hard disk 641 and/or removable media drive 642 may contain one or more data stores and data files used by embodiments of the present disclosure. The data store 640 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 620 may also be employed in a multi-processing arrangement to execute the one or more sequences of instructions contained in system memory 630. In alternative embodiments, hard-wired circuitry may be used in place of or in combination with software instructions. Thus, embodiments are not limited to any specific combination of hardware circuitry and software.

As stated above, the computer system 610 may include at least one computer readable medium or memory for holding instructions programmed according to embodiments of the invention and for containing data structures, tables, records, or other data described herein. The term “computer readable medium” as used herein refers to any medium that participates in providing instructions to the processors 620 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 641 or removable media drive 642. Non-limiting examples of volatile media include dynamic memory, such as system memory 630. Non-limiting examples of transmission media include coaxial cables, copper wire, and fiber optics, including the wires that make up the system bus 621. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 600 may further include the computer system 610 operating in a networked environment using logical connections to one or more remote computers, such as remote computing device 673. The network interface 670 may enable communication, for example, with other remote devices 673 or systems and/or the storage devices 641, 642 via the network 671. Remote computing device 673 may be a personal computer (laptop or desktop), a mobile device, a server, a router, a network PC, a peer device or other common network node, and typically includes many or all of the elements described above relative to computer system 610. When used in a networking environment, computer system 610 may include modem 672 for establishing communications over a network 671, such as the Internet. Modem 672 may be connected to system bus 621 via user network interface 670, or via another appropriate mechanism.

Network 671 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., remote computing device 673). The network 671 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 671.

It should be appreciated that the program modules, applications, computer-executable instructions, code, or the like depicted in FIG. 6 as being stored in the system memory 630 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 610, the remote device 673, and/or hosted on other computing device(s) accessible via one or more of the network(s) 671, may be provided to support functionality provided by the program modules, applications, or computer-executable code depicted in FIG. 6 and/or additional or alternate functionality. Further, functionality may be modularized differently such that processing described as being supported collectively by the collection of program modules depicted in FIG. 6 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 6 may be implemented, at least partially, in hardware and/or firmware across any number of devices.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer system for dynamic assessment of stability for a power grid, the computer system comprising:
a processor; and
a memory having algorithmic modules stored thereon executable by the processor, the modules comprising:
an energy market management (EMM) module configured to:
derive an energy market dispatch for a mix of generation sources including renewable and non-renewable types based on a steady state optimization of supplier cost and a power demand forecast; and
a dynamic security assessment (DSA) module configured to:
perform a dynamic contingency assessment of stability for the power transmission system based on the mixed generation sources defined by the energy market dispatch; and
send feedback to the EMM module with results of the dynamic assessment of stability;
wherein the EMM module clears the energy market dispatch on a condition that feedback indicates a stable dynamic assessment.

2. The computer system of claim 1, wherein the dynamic contingency assessment by the DSA module is performed using an N−1 contingency analysis.

3. The computer system of claim 1, wherein the DSA module comprises a rule-based stability service agent module configured to:
identify one or more stability services and asset locations using rule-based algorithms, on a condition that the dynamic contingency assessment indicates an unstable dynamic assessment.

4. The computer system of claim 1, wherein the stability services include at least one of the following:
a flexible AC transmission system;
a high-voltage DC terminal,
a synchronous condenser;
a controllable generator;
a battery storage system; or
a controllable load.

5. The computer system of claim 1, wherein the DSA module comprises a dynamic security optimization (DSO) module configured to:
generate a dynamic model of the power grid based on critical contingencies describing temporal change in variables including one or more of voltage, power and frequency;
determine control parameters for amplitude and frequency of a voltage in a first node of the model representing a non-renewable generation source on a basis of a reactive power and of an active power of the first node; and
determine control parameters for active power and reactive power of a second node of the model representing a renewable energy generation source based on frequency and amplitude of voltage in the second node; and
adjust the control parameters using optimization criteria related to stability.

6. The computer system of claim 1, wherein the DSA module comprises a reinforcement learning (RL)-based stability service agent module configured to:
identify one or more stability services and asset locations using reinforcement learning algorithms with a mix of continuous and discrete optimization parameters, wherein each stability service is related to operation parameters of a renewable generation source on a condition that the dynamic contingency assessment indicates an unstable dynamic assessment,
wherein the RL-based module is trained offline using data from historical dispatch events including at least one unresolved event and optimized to achieve dynamic stability by selecting one or more stability services.

7. The computer system of claim 6, wherein the continuous optimization parameters include a curtailment factor on power delivery from a renewable energy asset to create headroom for fast frequency response or virtual inertia.

8. The computer system of claim 6 wherein the discrete optimization parameters include an amount of large-scale battery storage able to provide grid-forming control behavior.

9. A computer-implemented method for dynamic assessment of stability for a power grid, the computer system comprising:
deriving, by an energy market management module, an energy market dispatch for a mix of generation sources including renewable and non-renewable types based on a steady state optimization of supplier cost and a power demand forecast; and
performing a dynamic contingency assessment of stability for the power transmission system based on the mixed generation sources defined by the energy market dispatch;
sending feedback to the energy market module with results of the dynamic assessment of stability; and
clearing, by the energy market management module, the energy market dispatch on a condition that feedback indicates a stable dynamic assessment.

10. The method of claim 9, wherein the dynamic contingency assessment is performed using an N−1 contingency analysis.

11. The method of claim 9, further comprising:
identifying one or more stability services and asset locations using rule-based algorithms, wherein each stability service is related to operation parameters of a renewable generation source on a condition that the dynamic contingency assessment indicates an unstable dynamic assessment.

12. The method of claim 9, further comprising:
generating a dynamic model of the power grid based on critical contingencies describing temporal change in variables including one or more of voltage, power and frequency;
determining control parameters for amplitude and frequency of a voltage in a first node of the model representing a non-renewable generation source on a basis of a reactive power and of an active power of the first node; and
determining control parameters for active power and reactive power of a second node of the model representing a renewable energy generation source based on frequency and amplitude of voltage in the second node; and
adjusting the control parameters using optimization criteria related to stability.

13. The method of claim 9, further comprising:
identifying one or more stability services and asset locations using reinforcement learning algorithms with a mix of continuous and discrete optimization parameters, wherein each stability service is related to operation parameters of a renewable generation source on a condition that the dynamic contingency assessment indicates an unstable dynamic assessment,
wherein the RL-based module is trained offline using data from historical dispatch events including at least one unresolved event and optimized to achieve dynamic stability by selecting one or more stability services.

14. The method of claim 13, wherein the continuous optimization parameters include a curtailment factor on power delivery from a renewable energy asset to create headroom for fast frequency response or virtual inertia.

15. The method of claim 13, wherein the discrete optimization parameters include an amount of large-scale battery storage able to provide grid-forming control behavior.
